(19) United States
(12) Patent Application Publication
(10) Pub. No.: US 2026/0012917 A1
(43) Pub. Date: Jan. 8, 2026

(54) WIRELESS COMMUNICATION METHOD AND DEVICE

(71) Applicants: GUANGDONG OPPO MOBILE TELECOMMUNICATIONS CORP., LTD., Dongguan (CN); TSINGHUA UNIVERSITY, Beijing (CN)

(72) Inventors: Yuan SHEN, Dongguan (CN); Yuxiao LI, Dongguan (CN); Yang LIU, Dongguan (CN); Xinlei YU, Dongguan (CN); Qianxi LU, Dongguan (CN); Cong SHI, Dongguan (CN)

(21) Appl. No.: 19/324,856

(22) Filed: Sep. 10, 2025

Related U.S. Application Data
(63) Continuation of application No. PCT/CN2023/084878, filed on Mar. 29, 2023.

(51) Int. Cl. H04W 64/00

(52) U.S. Cl. CPC H04W 64/00

(57) ABSTRACT

A wireless communication method and device are provided. The method includes that: the distribution of positional features between a user node and at least three signal source nodes is acquired; and the position of the user node is determined according to the distribution of the positional features between the user node and the at least three signal source nodes.

### CROSS-REFERENCE TO RELATED APPLICATION

This is a continuation application of International Patent Application No. PCT/CN2023/084878, filed on Mar. 29, 2023, entitled “WIRELESS COMMUNICATION METHOD AND DEVICE”, the disclosure of which is hereby incorporated by reference in its entirety.

### BACKGROUND

In an indoor positioning system, a detectable wireless signal, such as an ultra-wide band (UWB) signal, a WiFi signal, or a Bluetooth signal, is usually used for positioning, and basic positioning algorithms include a tag positioning method, a triangulation positioning method, and a fingerprint positioning method.

Conventional indoor positioning methods all have the problem of poor positioning precision in complex environments (such as scenarios containing multipath or background noise, non-line-of-sight scenarios, etc.). Therefore, how to achieve positioning precision in complex environments is an urgent problem to be solved.

### SUMMARY

Embodiments of the present disclosure relate to the field of communications, and relate specifically to a method and device for wireless communication. The present disclosure provides a method and device for wireless communication.

In a first aspect, there is provided a method for wireless communication, the method includes the following operations.

Distributions of positional features between a user node and at least three signal source nodes are obtained.

A position of the user node is determined according to the distributions of the positional features between the user node and the at least three signal source nodes.

In a second aspect, there is provided a device for wireless communication, including a processor and a memory. The memory is used to store a computer program, and the processor is used to call and run the computer program stored in the memory to cause the device to: obtain distributions of positional features between a user node and at least three signal source nodes; and determine a position of the user node according to the distributions of the positional features between the user node and the at least three signal source nodes.

In a third aspect, there is provided a non-transitory computer-readable storage medium, used to store a computer program that causes a computer to: obtain distributions of positional features between a user node and at least three signal source nodes; and determine a position of the user node according to the distributions of the positional features between the user node and the at least three signal source nodes.

### BRIEF DESCRIPTION OF THE DRAWINGS

FIG. 1 is a schematic diagram of a communication system architecture provided in an embodiment of the present disclosure.

FIG. 2 is a schematic diagram of a method for wireless communication provided according to an embodiment of the present disclosure.

FIG. 3 is a schematic diagram of a positioning method in the related art.

FIG. 4 is a schematic diagram of a positioning method according to an embodiment of the present disclosure.

FIG. 5 is a schematic diagram of a target model provided according to an embodiment of the present disclosure.

FIG. 6 is a schematic structural diagram of another target model provided according to an embodiment of the present disclosure.

FIG. 7 is a schematic block diagram of a device for wireless communication provided according to an embodiment of the present disclosure.

FIG. 8 is a schematic block diagram of a communication device provided according to an embodiment of the present disclosure.

FIG. 9 is a schematic block diagram of a chip provided according to an embodiment of the present disclosure.

FIG. 10 is a schematic block diagram of a communication system provided according to an embodiment of the present disclosure.

### DETAILED DESCRIPTION

The technical solution in the embodiments of the present disclosure is described below with reference to the drawings in the embodiments of the present disclosure. Evidently, the described embodiments are part of the embodiments of the present disclosure, rather than all of the embodiments. All other embodiments that are arrived at by a person of ordinary skill in the art for the embodiments in the present disclosure without involving inventive effort fall within the scope of protection of the present disclosure.

The technical solutions of the embodiments of the present disclosure are applicable to various communication systems, such as a Global System of Mobile Communication (GSM), a Code Division Multiple Access (CDMA) system, a Wideband Code Division Multiple Access (WCDMA) system, a General Packet Radio Service (GPRS), a Long-Term Evolution (LTE) system, an Advanced Long-Term Evolution (LTE-A) system, a New Radio (NR) system, an evolved system of an NR system, an LTE-based Access to Unlicensed Spectrum (LTE-U) system, an NR-based Access to Unlicensed Spectrum (NR-U) system, a non-terrestrial network (NTN) system, a Universal Mobile Telecommunication System (UMTS), a wireless local area network (WLAN), Wireless Fidelity (WiFi), a 5th-generation (5G) communication system, or other communication systems.

Generally speaking, conventional communication systems support a limited number of connections and are easy to implement. However, with the development of communication technologies, mobile communication systems will not only support conventional communications, but also support, for example, Device to Device (D2D) communication, Machine to Machine (M2M) communication, Machine Type Communication (MTC), Vehicle to Vehicle (V2V) communication, and Vehicle to Everything (V2X) communication, etc. The embodiments of the present disclosure are also applicable to these communication systems.

Optionally, a communication system in an embodiment of the present disclosure may be applicable to a Carrier Aggregation (CA) scenario, a Dual Connectivity (DC) scenario, or a Standalone (SA) deployment scenario.

Optionally, a communication system in an embodiment of the present disclosure may be applicable to an unlicensed spectrum, wherein the unlicensed spectrum may also be considered as a shared spectrum. Alternatively, the communication system in the embodiment of the present disclosure may also be applicable to a licensed spectrum, wherein the licensed spectrum may also be considered as an unshared spectrum.

The embodiments of the present disclosure describe various embodiments in conjunction with a network device and a terminal device, wherein the terminal device may also be referred to as a user equipment (UE), an access terminal, a subscriber unit, a user station, a mobile station, a mobile site, a remote station, a remote terminal, a mobile device, a user terminal, a terminal, a wireless communication device, a user agent, or a user apparatus, etc.

The terminal device may be a STATION (STA) in a WLAN, a cellular phone, a cordless phone, a Session Initiation Protocol (SIP) phone, a Wireless Local Loop (WLL) station, a Personal Digital Assistant (PDA) device, a handheld device having a wireless communication function, a computing device or another processing device connected to a wireless modem, a vehicle-mounted device, a wearable device, a terminal device in a next-generation communication system such as an NR network, or a terminal device in a future evolved Public Land Mobile Network (PLMN) network, etc.

In the embodiments of the present disclosure, the terminal device may be deployed on land, including an indoor or outdoor device, a handheld device, a wearable device, or a vehicle-mounted device; it may also be deployed on the surface of water (such as a ship, etc.); it may also be deployed in the air (e.g., on an airplane, a balloon, a satellite, etc.).

In the embodiments of the present disclosure, the terminal device may be a mobile phone, a tablet computer (Pad), a computer with a wireless transceiving function, a Virtual Reality (VR) terminal device, an Augmented Reality (AR) terminal device, a wireless terminal device in industrial control, a wireless terminal device in self-driving, a wireless terminal device in remote medical care, a wireless terminal device in a smart grid, a wireless terminal device in transportation safety, a wireless terminal device in a smart city, a wireless terminal device in a smart home, etc.

As an example rather than a limitation, in the embodiments of the present disclosure, the terminal device may also be a wearable device. The wearable device may also be referred to as a wearable smart device, and is a general term for wearable devices that are developed by intelligently designing daily wear applying a wearable technology, such as glasses, gloves, watches, clothes, and shoes. The wearable device is a portable device that is directly worn on the body or integrated into clothes or an accessory of a user. The wearable device is not only a hardware device, but also implements powerful functions by means of software support, data interaction, and cloud interaction. In a broad sense, wearable smart devices include those that are fully functional and large in size, and can implement complete or partial functions without dependence on smart phones, such as smart watches or smart glasses, and those that only focus on a certain type of application function and need to be used in cooperation with other devices such as smart phones, such as various smart bracelets, smart jewelry, etc., for monitoring physical signs.

In the embodiments of the present disclosure, the network device may be a device used to communicate with a mobile device, and the network device may be an Access Point (AP) in a WLAN, a Base Transceiver Station (BTS) in GSM or CDMA, a NodeB (NB) in WCDMA, an Evolutional Node B (eNB or eNodeB) in LTE, a relay station or an access point, a vehicle-mounted device, a wearable device, a network device (gNB) in an NR network, a network device in a future evolved PLMN network, a network device in an NTN network, or the like.

As an example rather than a limitation, in the embodiments of the present disclosure, the network device may have a mobile characteristic. For example, the network device may be a mobile device. Optionally, the network device may be a satellite or a balloon station. For example, the satellite may be a Low-Earth Orbit (LEO) satellite, a Medium-Earth Orbit (MEO) satellite, a Geostationary Earth Orbit (GEO) satellite, a High Elliptical Orbit (HEO) satellite, or the like. Optionally, the network device may also be a base station disposed on land, in water, etc.

In the embodiments of the present disclosure, the network device may serve a cell, and the terminal device communicates with the network device by means of a transmission resource (for example, a frequency domain resource or a spectrum resource) used by the cell. The cell may be a cell corresponding to the network device (for example, a base station). The cell may belong to a macro base station or a base station corresponding to a small cell. The small cell herein may include: a metro cell, a micro cell, a pico cell, a femto cell, etc. These small cells have the characteristics of small coverage and low transmit power, and are suitable for providing high-rate data transmission services.

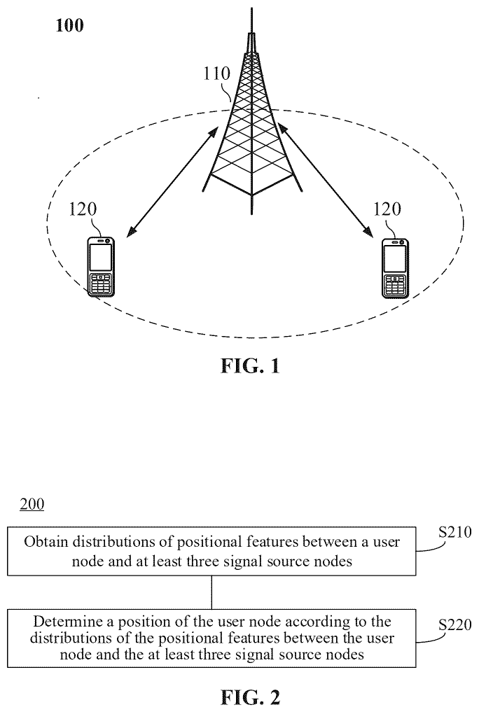

As an example, a communication system 100 applied in an embodiment of the present disclosure is illustrated in FIG. 1. The communication system 100 may include a network device 110, and the network device 110 may be a device that communicates with a terminal 120 (or referred to as a communication terminal or a terminal). The network device 110 can provide communication coverage for a particular geographic region, and can communicate with a terminal device located within the coverage region.

FIG. 1 exemplarily illustrates one network device and two terminal devices. Optionally, the communication system 100 may include a plurality of network devices, and the coverage range of each network device may include other numbers of terminal devices. The embodiments of the present disclosure are not limited thereto.

Optionally, the communication system 100 may further include a network controller, a mobile management entity, and other network entities. The embodiment of the present disclosure is not limited thereto.

It should be understood that a device having a communication function in the network/system in the embodiments of the present disclosure may be referred to as a communication device. Using the communication system 100 illustrated in FIG. 1 as an example, the communication device may include a network device 110 and a terminal device 120 having a communication function, and the network device 110 and the terminal device 120 may be specific devices described above. Details are not described herein again. The communication device may further include other devices in the communication system 100, such as a network controller, a mobility management entity, and other network entities, and the embodiments of the present disclosure are not limited thereto.

It is to be understood that the terms “system” and “network” herein are often used interchangeably herein. The term “and/or” herein is merely to describe the associations between associated objects, indicating that there can be three kinds of relationships. For example, A and/or B, which may indicate three situations in which A exists alone, A and B exist simultaneously, or B exists alone. In addition, the character “/” herein generally indicates that the associated objects before and after this character are in an “or” relationship.

It should be understood that “indicating” mentioned in the embodiments of the present disclosure may be a direct indication or an indirect indication, or may also represent an association. For example, A indicating B may mean that A directly indicates B, for example, B may be obtained from A; it may also mean that A indirectly indicates B, for example, A indicates C, and B may be obtained from C; it may also mean that there is an association between A and B.

In the description of the embodiments of the present disclosure, the term “corresponding” may represent that there is a direct correspondence or indirect correspondence between two objects, or may represent an association therebetween, or may be the relationship between indicating and being indicated and configuring and being configured, etc.

In the embodiments of the present disclosure, “predefined” may be implemented by pre-storing corresponding codes, tables, or other means available for indicating relevant information in a device (e.g., including a terminal device and a network device), and the present disclosure does not limit the specific implementation of the present disclosure. For example, a predefined may refer to being defined in a protocol.

In the embodiments of the present disclosure, the “protocol” may refer to a standard protocol in the field of communications, for example, it may include an LTE protocol, an NR protocol, and related protocols applied to future communication systems, and the present disclosure is not limited thereto.

To facilitate understanding of the technical solutions of the embodiments of the present disclosure, positioning technology in the communication system will be described.

In an indoor positioning system, a detectable wireless signal, such as an ultra-wide band (UWB) signal, a WiFi signal, or a Bluetooth signal, is usually used for positioning, and basic positioning algorithms include a tag positioning method, a triangulation positioning method, and a fingerprint positioning method.

The tag positioning method is also referred to as a neighbor method. Specifically, the position of an indoor signal source is obtained first as an anchor point for estimating the position of a user, signal scanning is then performed, and when signals sent by signal source nodes in a database are scanned, the position of a signal source having the greatest received signal strength (RSS) is used as a position estimate of the user node.

The triangulation method includes a distance measurement-based method and an angle measurement-based method. Specifically, position parameters or positioning parameters such as distances or angles between the user and the signal sources are first estimated by means of receiving signals, and then the position of the user node is determined by a basic geometric operation. Using the distance-based triangulation method as an example, in the method, the geometric positions of the signal sources are obtained in advance, and when signals sent by three known signal sources are scanned, the straight-line distances from the three known signal sources to the user node are estimated, and triangulation calculation for positioning is performed to obtain a position estimate of the user node.

The fingerprint positioning method is a variant of the triangulation positioning method, and a position estimate of the user node is derived by comparing the received signal strength (for example, fingerprint information) of the user node with a regional distribution of indoor wireless signal strength to find the best matching region. In the method, the distribution of indoor wireless signal strength needs to be obtained in advance; a fingerprint library is established; then, the RSS of the signal received by the user node is compared with the fingerprint library, and a position set having the smallest difference is used as an optimal positioning region; and the centroid of an overlapping part of the optimal positioning regions for all signal sources is a position estimate of the user node.

In addition to the positioning system, there are some methods for improving the positioning precision by means of machine learning, which are combined with the above positioning system to improve the position estimation precision. These optimization methods include, for example, support vector machine (SVM) and random forest (RF), in which manually defined statistical features are first used, and a measurement error of a distance or angle is then estimated based on these features by a machine learning method, so as to compensate for single-value estimation directly obtained, which is advantageous for the final high-precision positioning.

The three types of common indoor positioning methods described above all have the problem of poor positioning precision in complex environments (such as scenarios containing multipath or background noise, non-line-of-sight scenarios, etc.). The tag positioning method is simple to deploy, and the positioning precision depends on the deployment density of signal sources, so that only regions labeled by tags in an early stage can be identified, and positioning cannot be performed for regions not covered by the tags. Therefore, the positioning precision is poor, and only meter-level precision can be achieved. The triangulation positioning method has theoretically high precision. However, in an actual indoor positioning scenario, it is easily affected by the environment, such as reflections, obstacles, and the like, which cause multipath and non-line-of-sight occurrences. As a result, accurate estimates of position parameters such as distances and angles cannot be obtained, thus, the geometric method cannot obtain a unique position estimate, greatly affecting the precision and robustness of the positioning result. The fingerprint positioning method has a large workload of establishing a fingerprint library in the early stage, poor scalability to different scenarios, and is prone to regional interference, that is, erroneous position estimation is prone to occur when different survey regions have the same wireless fingerprint signal.

For the machine learning methods for optimizing the estimation precision based on the above indoor positioning methods, on the one hand, they can achieve the effect of greatly improving the measurement estimation precision, but are limited by a large amount of computation for manually extracting features. The effect also depends on the design of the features, so these methods cannot be automatically generalized to new task scenarios using different radio frequency signals. On the other hand, these methods are still limited to single-value estimation of distances/angles, and it is difficult to make full use of all possible estimated values during the positioning process to improve the final positioning performance.

In summary, these existing positioning methods are all single-valued point estimation based on a measured positional feature such as a distance or an angle, and some position information in the signals is lost, so that the positioning precision is highly dependent on the precision of single-value estimation, and the global robustness is poor. Moreover, the models have a limited capacity, and cannot fully utilize potential high-dimensional environmental information in signals such as multipath signals, and therefore it is difficult to directly apply the models to more complex and generalized positioning scenarios.

In view of this, the embodiments of the present disclosure provide a positioning solution, in which positioning is performed based on distribution information of position parameters carried in wireless signals, so that position information carried in the wireless signals can be fully utilized, thereby improving positioning precision and global robustness.

To facilitate understanding of the technical solution of the embodiments of the present disclosure, the technical solution of the present disclosure will be described in detail below by means of specific embodiments. The following related techniques can be arbitrarily combined with the technical solution of the embodiments of the present disclosure as optional solutions, all of which fall within the scope of protection of the embodiments of the present disclosure. The embodiments of the present disclosure include at least some of the following content.

FIG. 2 is a schematic flowchart of a method 200 for wireless communication according to an embodiment of the present disclosure. As illustrated in FIG. 2, the method 200 includes at least some of the following content:
S210, obtaining distributions of positional features between a user node and at least three signal source nodes; and
S220, determining a position of the user node according to the distributions of the positional features between the user node and the at least three signal source nodes.

It should be understood that the embodiment of the present disclosure may be applied to various scenarios in which positioning is performed based on radio frequency signals, such as a complex indoor environment including an obstacle, or may be applied to other positioning scenarios, such as a simple environment, an environment with different room structures, or an indoor high-density loss environment, which is not limited in the present disclosure.

In some embodiments, the positions of the signal source nodes are known, or same are referred to as anchor devices.

In some embodiments, the position of the user node is unknown, or same is referred to as a device to be positioned.

In some embodiments, the user node may be a terminal device in a communication system, such as a UE in a cellular communication system, a STA in a WiFi system, or the like.

In some embodiments, the signal source node may be a terminal device of which the position is known in the communication system, or may be a network device in the communication system, such as a TRP or a base station, which is not limited in the present disclosure.

In some embodiments, the method 200 may be performed by the device to be positioned, or may be performed by a positioning node, wherein the positioning node may be a positioning server, a location management function (LMF) entity, a central base station, or the like.

For example, the signal source nodes may send signals, and the user node may receive the signals sent by the signal source nodes, and determine the position of the user node based on the received signals; or the user node may report information about the received signals to the positioning node, and the positioning node determines the position of the user node based on the information about the received signals.

It should be understood that the type of signal sent by each signal source node is not limited in the embodiments of the present disclosure, and may be, for example, a UWB signal, a 5G signal, a cellular signal, a Bluetooth signal, a WiFi signal, etc.

In some embodiments, a positional feature (or referred to as a positioning parameter or a position parameter) may be an angle, a distance, an RSS, etc., which is not limited in the present disclosure. Distance features will be used as an example for description below, but the present disclosure is not limited thereto.

In an application scenario of the embodiments of the present disclosure, there may be Nₐ signal source nodes and Ng user nodes. The positions of the signal source nodes are known. The signal source nodes may send wireless signals. The positions of the user nodes are unknown. Positioning and environment sensing are performed by receiving the signals. The position of user node k is expressed as pₖ=[xₖ, yₖ]^{T}, and a parameter vector including the positions of all user nodes is

$$p = {[ {p}_{1}^{T} , {p}_{2}^{T} , … , {p}_{{N}_{b}}^{T} ]}^{T} ;$$

an environmental tag of an environment where the user node is located is lₖ, and k∈N_{b}. Environmental tags corresponding to different user nodes may be the same or different.

It should be understood that, in the embodiments of the present disclosure, the environmental tags may be designed based on a specific positioning scenario. For example, in a complex indoor environment, the environmental tags in Table 1 or 2 may be used, and in other positioning scenarios, the environmental tags may also be replaced with other environmental feature (for example, simple environment, room geometric structure, or outdoor obstacle density) tags, which is not limited in the present disclosure.

For a positioning method based on distance features, the distance dkj from user node k to signal source node j is a position parameter of user node k, which is expressed as: dₖⱼ=∥pₖ-pⱼ∥.

In some embodiments, a signal received by user node k from signal source node j may be expressed in the following form:

$${r}_{kj} ( t ) = {\sum }_{l = 1}^{L} {α}_{kj}^{( l )} {s}_{j} ( t - {τ}_{kj}^{( l )} )$$

where sⱼ(t) is a known signal, L is a number of multipaths, l={1, 2, . . . , L} represents different transmission links of the signal,

$${α}_{kj}^{( l )} and {τ}_{kj}^{( l )}$$

are the corresponding amplitude and delay of the signal on a l-th transmission link from signal source node j to user node k, respectively, and n(t) is white Gaussian noise.

In the related art, a simple estimation algorithm based on a first arrival path is built in a wireless signal receiver in a user node, and the user node may estimate a pseudo-distance \tilde{d}ₖⱼ between a signal source node and the user node according to a received signal, wherein a pseudo-distance model is expressed as:

$${\tilde{d}}_{kj} = {d}_{kj} + {b}_{k}$$

wherein bx is a distance estimation deviation introduced due to multipaths, non-line of sight, scenario noise, etc.; for LOS environments, generally bₖ≈0, and for NLOS environments, generally bₖ≥0.

In some embodiments, considering that the signals received by the user node include environmental information, environmental tags are used to represent environment categories. It should be understood that the present disclosure does not limit specific labeling methods of the environmental tags. For example, the environmental tags may be labeled according to the presence or absence of obstacles, the number of obstacles, the type (such as the material, etc.) of obstacles, the environment, the size of the space, etc.

As an example, the labeling method in Table 1 may be used:

TABLE 1

| lₖ = 0 | lₖ = 1 | lₖ = 2 | lₖ = 3 | lₖ = 4 |
|---|---|---|---|---|
| No obstacle | Metal | Plastic | Wooden | Glass |
| | obstacle | obstacle | obstacle | obstacle |

As another example, the labeling method in Table 2 may be used:

TABLE 2

| lₖ = 0 | lₖ = 1 | lₖ = 2 | lₖ = 3 | lₖ = 4 |
|---|---|---|---|---|
| Outdoor | Large room | Medium-sized room | Small room | Corridor |

In practical applications, a distance measurement error bₖ may be influenced by environmental factors, that is, bx is related to the environmental tag lₖ. For example, when lₖ=0, generally bₖ≈0; when lₖ≠0, generally bₖ≥0, and different deviation values bx are related to the dielectric coefficients of obstructions corresponding to the environmental tag lₖ. When the dielectric coefficient of an obstruction is large, the attenuation and the first arrival path delay caused by a signal penetrating the obstruction are correspondingly increased, thereby causing the distance measurement deviation to be increased and the distance measurement precision to be reduced.

In the related art, for a positioning system based on distance measurement, a user node may receive signals from at least three signal source nodes, and positioning is performed by using a geometric relationship. A specific implementation is as illustrated in FIG. 2, wherein it is assumed that user node k receives signals from signal source node j, signal source node m, and signal source node n. It is known that positions of the three signal source nodes are pⱼ, pₘ, pₙ, respectively; three distances \hat{d}ₖⱼ, \hat{d}ₖₘ, \hat{d}ₖₙ are estimated according to the signals received from the three signal source nodes. Further, circles are respectively drawn with the positions of the three signal source nodes as the centers of the circles and the distances from user node k to the signal source nodes as the radii, and the intersection point of the three circles is the estimated position of user node k. When the three circles do not intersect, a point in space with the maximum probability value is obtained through the maximum a posteriori distribution, and is used as the position estimate of the user node.

In the embodiments of the present disclosure, when positioning is performed by using the distance features, the user node may receive signals of at least three signal source nodes, the received signals may be used to estimate distributions of distances between the user node and the signal source nodes, and further, the position of user node k may be estimated based on the distributions of the distances between the user node and the at least three user nodes.

In some embodiments of the present disclosure, S220 includes:
according to a distribution of the positional feature included in a signal sent by each of the at least three signal source nodes, determining at least three regions, wherein each of the at least three regions corresponds to one of the at least three signal source nodes, and each region is determined according to the distribution of the positional feature included in the signal sent by the corresponding signal source node; and
determining a point having a maximum probability value in the at least three regions as the position of the user node.

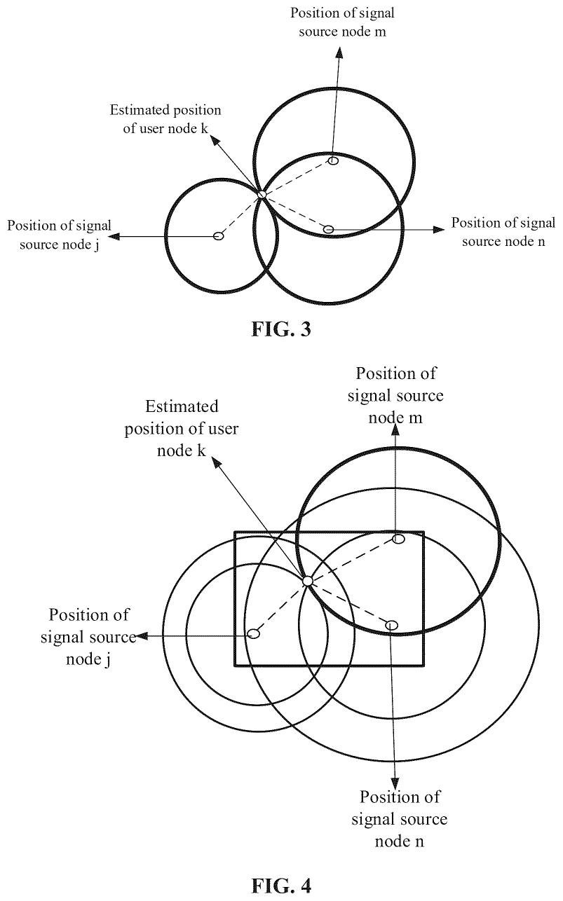

A specific implementation is described with reference to FIG. 3. As illustrated in FIG. 3, the at least three signal source nodes include signal source node j, signal source node m, and signal source node n, a signal received by user node k from signal source node j is denoted as rₖⱼ, a signal received by user node k from signal source node m is denoted as rₖₘ, and a signal received by user node k from signal source node n is denoted as rₖₙ.

Then, in S210, a distribution (denoted as p(xₖⱼ|rₖⱼ)) of a positional feature xₖⱼ between user node k and signal source node j may be determined according to rₖⱼ, a distribution (denoted as p(xₖₘ|rₖₘ)) of a positional feature xₖₘ between user node k and signal source node m may be determined according to rₖₘ, and a distribution (denoted as p(xₖₙ|rₖₙ)) of a positional feature xₖₙ between user node k and signal source node n can be determined according to rₖₙ.

Further, according to p(xₖⱼ|rₖⱼ), p(xₖₘ|rₖₘ), and p(xₖₙ|rₖₙ), the position of the user node is determined.

For example, region j may be determined according to the distribution p(xₖⱼ|rₖⱼ) of the positional feature xₖⱼ and the position of signal source node j, region m may be determined according to the distribution p(xₖₘ|rₖₘ) of the positional feature xₖₘ and the position of signal source node m, and region n may be determined according to the distribution p(xₖₙ|rₖₙ) of the positional feature xₖₙ and the position of signal source node n.

For example, using signal source node j as the center of the circle, a circle is drawn with possible values of the distribution of the positional feature xₖⱼ to obtain region j;
using signal source node m as the center of the circle, a circle is drawn with possible values of the distribution of the positional feature xₖₘ to obtain region m; and
using signal source node n as the center of the circle, a circle is drawn with possible values of the distribution of the positional feature xₖₙ to obtain region n.

Further, a point having maximum possibility in region j, region m, and region n is used as an estimated position of user node k.

For example, a point in space having the maximum probability value is obtained according to the maximum a posteriori distribution, and is used as the position estimate of the user node, that is:

$${\hat{p}}_{k} = arg {max}_{{p}_{k}} p ( {p}_{k} \vert {x}_{kj} , {x}_{km} , {x}_{kn} ) \qquad ( 1 )$$

Hereinafter, an inference algorithm for the distributions of the positional features between the user node and the source nodes will be described in detail.

In some embodiments of the present disclosure, S210 includes:
determining a first distribution (denoted as p(z|r)) according to the signal sent by each signal source node and received by the user node, wherein the first distribution is a distribution of environmental information (or referred to as environmental feature) included in the signal;
determining a second distribution (denoted as p(x|r, z)) according to the signal sent by each signal source node and received by the user node, wherein the second distribution is a distribution of the positional feature of the signal under the environmental information of the first distribution; and
determining a target distribution (denoted as p(x|r)) according to first distributions and second distributions, wherein the target distribution is a distribution of the positional features included in the signals.

z represents the environmental information, r represents the received signal, and x represents the positional feature.

In some embodiments, the operation of determining the target distribution according to the first distributions and the second distributions includes:
determining the target distribution p(x|r) according to the Bayes formula:

$$p ( x \vert r ) = {\sum }_{z} p ( z \vert r ) p ( x \vert r , z ) \qquad ( 2 )$$

where r represents the received signal, z represents the environmental information, x represents the positional feature, p(z|r) represents the distribution of the environmental information z included in the signal r, and p(x|r, z) represents the distribution of the positional feature included in the signal r under the environmental information z.

In some embodiments, the distribution information of the positional feature is soft information (SI) of the positional feature, or the distribution information of the positional feature is determined according to the soft information of the positional feature.

In some embodiments, the distribution information of the environmental feature is soft information of the environmental feature, or the distribution information of the environmental feature is determined according to the soft information of the environmental feature.

In some embodiments, wireless signals received by the user node include rich environmental information and positional feature information between the user node and source nodes, so that the distribution of the environment where the signals are located (that is, the environmental information between the user node and the source nodes) may be inferred based on the signals received by the user node, and the distributions of the positional features in the environmental distribution may be inferred. Further, the distribution of the positional features between the user node and the signal source nodes may be determined based on the environmental distribution and the distributions of the positional features in the environmental distribution.

In some embodiments, it may be defined that the received signal r may be decomposed into variables in a latent space: a positional feature variable x and an environmental variable z, wherein the environmental variable may correspond to an environmental tag 1, and the distribution of the above variables satisfies:

$$p ( r , x , z , l ) = p ( l ) p ( z \vert l ) p ( r , x \vert z ) \qquad ( 3 )$$

where the environment variable z includes information related to the environment tag l, and the received signal r may be determined by the environment variable z and the positional feature x.

In some embodiments, an a priori distribution of the environmental variable z is assumed to be a uniform distribution as follows:

$$p ( z ) = U ( z ; 1 , M ) \qquad ( 4 )$$

where the size of M is determined by the complexity of the environment. For example, in an indoor environment including line of sight (LOS) and non-line of sight (NLOS), M may be 2. For another example, in an environment with more types of obstacles, a larger value of M may be selected, so that the influences of different environmental features on the distribution of the positional feature can be controlled.

Since the original received signal r has a high dimension, and the distribution of the latent variable is complex relative to the transformation relationship of the received signal, it is difficult to construct and infer the above unknown distribution by using a conventional probability modeling method. Therefore, in the embodiments of the present disclosure, a model and a variational inference method are used to assist in estimating these complex distributions by accumulating knowledge from data. A derivation process of the algorithm will be described below.

In some embodiments, the target distribution is obtained based on a target model, wherein the target model includes a first network module (or referred to as an environmental encoder ø) and a second network module (or referred to as a positional feature distribution estimator (x), the first network module is used to infer the first distribution, and the second network module is used to infer the second distribution.

It should be understood that the specific implementation of the target model is not limited in the present disclosure. For example, the target model may be a deep learning network model, such as, specifically, a convolutional neural network (CNN), a recurrent neural network (RNN), or the like.

In some embodiments, the target model further includes:
a third network module (or referred to as an environmental estimator (1), used to infer a distribution of an environmental tag corresponding to an environment where the user node is located, which is recorded as a third distribution; and
a fourth network module or referred to as a decoder θ), used to derive a distribution of the received signal, denoted as a fourth distribution.

In some embodiments, an input of the first network module is the received signal, and an output of the first network module is a distribution parameter corresponding to the first distribution.

In some embodiments, inputs of the second network module are the received signal and environmental information outputted by the first network module, and an output of the second network module is a distribution parameter corresponding to the second distribution.

In some embodiments, an input of the third network module is the environmental information outputted by the first network module, and an output of the third network module is a distribution parameter corresponding to the third distribution.

In some embodiments, an input of the fourth network module is the environmental information outputted by the first network module, and an output of the third network module is a distribution parameter corresponding to the fourth distribution.

In some embodiments, using a variational inference method, a variational distribution q(z|r) is constructed to approximate an unknown joint feature distribution p(z|r), i.e., the first distribution. For example, the variational distribution may be a categorical distribution as follows:

$$q ( z \vert r ; ϕ ) = Cat ( z ; {π}_{z} ( r ; ϕ ) ) \qquad ( 5 )$$

where z is the environmental information, Iz is a parameter of the categorical distribution, ϕ is a neural network parameter for learning the distribution parameter π_{z}, r is the received signal, and π_{z} is the distribution parameter, that is obtained through learning and outputted, of the categorical distribution of the environmental information.

Further, it may be assumed that, based on the conditional distribution of the environmental variable z, the environmental tag l has the following categorical distribution:

$$q ( l \vert z ; {φ}_{l} ) = Cat ( l ; {π}_{l} ( z ; {φ}_{l} ) ) \qquad ( 6 )$$

where πₗ is a distribution parameter of the categorical distribution of the environmental tag l, φₗ is a neural network parameter for learning the distribution parameter πₗ, z is inputted environmental information, and πₗ is the distribution parameter, that is obtained through learning and outputted, of the categorical distribution of the environmental tag l.

In some embodiments, it is assumed that L_{r,z}(x) obeys the following Gaussian distribution:

$${L}_{r , z} ( x ) ∝ p ( x \vert r , z ; {φ}_{x} ) = N ( d ; {μ}_{x} ( r , z ; {φ}_{x} ) , {σ}_{x}^{2} ( r , z ; {φ}_{x} ) ) \qquad ( 7 )$$

where μₓ and σₓ² are distribution parameters of the Gaussian distribution, ox is a neural network parameter for learning the distribution parameters of the Gaussian distribution, r is the received signal, z is the environmental information, r and z are the inputs of the network, and μₓ and σₓ² are the distribution parameters, that are obtained through learning and outputted, of the Gaussian distribution of the positional features.

Further, it is assumed that, based on the conditional distribution of the environmental information z, the distribution of the received signal r is the following Gaussian distribution:

$$p ( r \vert z ; θ ) = N ( r ; {μ}_{r} ( z ; θ ) , {σ}_{r}^{2} ( z ; θ ) ) \qquad ( 8 )$$

where μᵣ, σᵣ² are the distribution parameters of the Gaussian distribution, θ is a neural network parameter for learning the distribution parameters of the Gaussian distribution, z is the environmental information, z is the input of the network, and μᵣ, σᵣ² are the distribution parameters, that are obtained through learning and outputted, of the Gaussian distribution of the received signal.

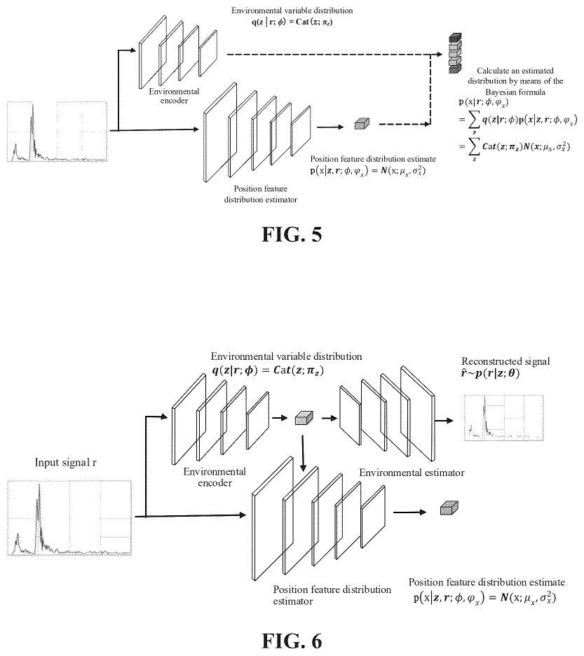

FIG. 5 illustrates a schematic structural diagram of a target model provided according to an embodiment of the present disclosure. Optionally, the model structure may be used in a testing or application phase.

FIG. 6 is a schematic structural diagram of another target model provided according to an embodiment of the present disclosure. Optionally, the model structure may be used in a training phase.

In some embodiments, the first network module and the fourth network device may form an autoencoder network, the autoencoder network corresponds to a loss function, the second network module corresponds to a loss function, and the third network module corresponds to a loss function.

In some embodiments, a global loss function L of the target model is:

$$L = {α}_{AE} {L}_{AE} + {α}_{dist} {L}_{dist} + {α}_{env} {L}_{env} \qquad ( 9 )$$

where α_{AE}, α_{dist}, αₑₙᵥ are training hyperparameters, L_{AE} is the loss function of the autoencoder network, L_{dist} is the loss function of the second network module, and Lₑₙᵥ is the loss function of the third network module. α_{AE}, α_{dist}, αₑₙᵥ are used for controlling the weights of the loss functions of the first network module, the second network module, and the third network module, and their values may be adjusted according to specific training results, for example, their initial values may all be 1.

In some embodiments, the loss function L_{AE} of the autoencoder network is:

$${{L}_{AE} ( r ; θ , ϕ ) = ‖ r - \hat{r} ( r ; θ , ϕ ) ) ‖}^{2} + {D}_{KL} ( Cat ( z ; {π}_{z} ( r ; ϕ ) ) ‖ U ( z ; 1 , M ) ) \qquad ( 10 )$$

where r represents the received signal, θ is a neural network parameter of the fourth network module, ϕ is a neural network parameter of the first network module, D_{KL} represents the KL divergence between distributions, Cat represents the categorical distribution, U represents the uniform distribution, z represents the environmental information, π_{z} represents the distribution parameter of environmental information, M is a parameter related to environmental complexity, and \hat{r}(r; θ, ϕ) represents a distribution of the received signal derived by the fourth network module.

In some embodiments, the loss function L_{dist} of the second network module is:

$${L}_{dist} ( r , z ; ϕ , {φ}_{x} ) = {E}_{q ( z \vert r )} {D}_{KL} ( {p}_{D} ( x ) ‖ N ( x ; {μ}_{x} ( r , z ; {φ}_{x} ) , {σ}_{x}^{2} ( r , z ; {φ}_{x} ) ) ) \qquad ( 11 )$$

where r represents the received signal, z represents the environmental information, ϕ is the neural network parameter of the first network module, φ_{d} is a neural network parameter of the second network module, q(z|r) represents a variational distribution, E_{q(z|r)} represents the expectation of q(z|r), p_{D}(x) is an empirical distribution of a position parameter x, D_{KL} represents the KL divergence between the distributions, N represents the Gaussian distribution, and μₓ and

$${σ}_{x}^{2}$$

represent the distribution parameters of the Gaussian distribution.

In some embodiments, the loss function Lₑₙᵥ of the third network module is:

$${L}_{env} ( r , l ; ϕ , {φ}_{l} ) = {E}_{q ( z \vert r )} {D}_{KL} ( {p}_{D} ( l ) ‖ Cat ( l ; {π}_{l} ( z ; {φ}_{l} ) ) ) \qquad ( 12 )$$

where r represents the received signal, l represents the environmental tag of the environment in which the user node is located, ϕ is the neural network parameter of the first network module, or is a neural network parameter of the third network module, q(z|r) represents the variational distribution, E_{q(z|r)} represents the expectation of q(z|r), p_{D}(l) is an empirical distribution of the environmental tag l, D_{KL} represents the KL divergence between the distributions, πₗ represents the distribution parameter of the environmental tag l, Cat represents the categorical distribution, and IT represents the distribution parameter of the categorical distribution.

A derivation process of the loss function of the target model will be specifically described below.

In some embodiments, a loss function for training the target model may be derived using a variational derivation algorithm.

For example, according to variational theory, the evidence variational lower bound L for the variational distribution q(z|r; ϕ) and the received signal r can be derived as:

$$L ( q ; r ) = - {D}_{KL} ( q ( z \vert r ) ‖ p ( z ) ) + {E}_{q ( z \vert r )} [ log p ( r \vert z ) ] + {E}_{q ( z \vert r )} [ log p ( d \vert r , z ) ] - {E}_{q ( z \vert r )} {D}_{KL} ( p ( l ) ‖ p ( l \vert z ) ) \qquad ( 13 )$$

where D_{KL}(⋅|⋅) represents the Kullback-Leibler (KL) divergence between the distributions.

This variational lower bound may be used to search for the optimal variational estimate variational distribution q(z|r) in a particular set of distributions. Assuming that the variational distribution is in the particular set of probability distributions Q, an optimal variational estimate can be solved by the following optimization problem:

$$q *= arg {max}_{q ∈ Q} L ( q ; r ) \qquad ( 14 )$$

To train a neural network, an objective function based on a variational inference algorithm may be converted into a loss function that can be used for neural network learning.

For example, the first and second terms −D_{KL}(q(z|r)∥p(z))+E_{q(z|r)}[log p(r|z)] of the objective function illustrated in formula (13) may correspond to the loss function of the autoencoder network. The loss function of the autoencoder network in formula (10) can be obtained taking into account the assumptions of the z distribution given in formulas (4) and (5).

The third term E_{q(z|r)}[log p(d|r, z)] of the objective function illustrated in formula (13) corresponds to the loss function of the second network module. The loss function of the second network module in formula (11) can be obtained taking into account the a priori distribution assumption of the environmental tag 1 given in formula (6). p_{D}(x) is the empirical distribution of the position parameter x in a dataset, which is given by a specific training dataset.

The fourth term E_{q(z|r)}D_{KL}(p(l)∥p(l|z)) of the objective function illustrated in formula (13) corresponds to the loss function of the third network module. After parameterization, the loss function in formula (12) can be obtained. p_{D}(l) is the empirical distribution of the environmental tag l in the dataset, which is given by the specific training dataset.

The overall network may be composed of an autoencoder network, a positional feature estimator, and an environment estimator, and these parts may be jointly optimized, so that the global loss function in formula (9) can be obtained.

The training and testing process of the target model will be described below.

In some embodiments of the present disclosure, the method 200 further includes:
constructing a training dataset, wherein the training dataset includes received signal information under a plurality of combinations of signal source node and user node, and ground truth values of the positional features between the user nodes and the signal source nodes; and
by using the received signal information in the training dataset as an input, using the distribution of the environmental information included in the received signal and the distribution of the positional feature of the received signal in the environmental information distribution as outputs, and using a deviation between an estimated value and a ground truth value of the positional feature in the training dataset as supervision, training the target model to obtain a neural network parameter of the target model.

In some embodiments, the training dataset may include environmental tag information corresponding to the received signal, and the output of the model may also include the distribution of the environmental tag.

In some other embodiments, received signal information in scenarios corresponding to different environmental tags, and positional feature information estimated by a device and real positional feature information may also be acquired based on a plurality of combinations of signal source node and user node, to construct the training dataset.

For example, by using the received signal information in the training dataset as an input, using the distribution of the deviation of the positional feature and the distribution of the environmental tag as outputs, and using the positional feature deviation (that is, the difference between the estimated positional feature information and the real positional feature information) in the training dataset and a ground truth value of the environmental tag as supervision, the network parameter is optimized by minimizing the difference between the estimated value outputted by the network and the ground truth value, the network parameter is iteratively updated until the training converges, and the loss function for iteratively updating the network parameter is as described in the foregoing embodiments.

In some embodiments of the present disclosure, the method 200 further includes:
inputting signals sent by the at least three signal source nodes and received by the user node into the trained target model, and outputting at least three first distributions and at least three second distributions, wherein the at least three first distributions and the at least three second distributions are in one to-one correspondence with the signals sent by the at least three signal source nodes;
estimating the distribution of the positional feature included in a corresponding signal according to each first distribution and a second distribution corresponding to the first distribution; and
determining the position of the user node according to the distributions of the positional features included in the signals sent by the at least three signal source nodes and the positions of the at least three signal source nodes.

For example, in the test phase, a signal rₖⱼ of signal source node j received by user node k may be used as an input, and the model parameters of the training number are used to output the distribution p(z|rₖⱼ) of the environmental information in the signal rₖⱼ, and the distribution p(x|rₖⱼ, z) of the positional feature in the signal rₖⱼ under the distribution of the environmental information. Further, based on p(z|rₖⱼ) and p(x|rₖⱼ, z) being substituted into the Bayesian formula (2), the distribution p(x|rₖⱼ) of the positional feature in the signal rₖⱼ can be obtained. Then, based on the signals sent by the three signal source nodes, the distribution of the positional feature in each signal may be obtained. Further, the position of user node k may be determined based on formula (1).

Therefore, in the embodiments of the present disclosure, according to each received signal of the user node, in the framework of the maximum likelihood estimation theory, a distribution of an environment in which the signal is located may be inferred by using a variational inference algorithm, and the distribution of the positional feature of the user node in different environmental conditions is derived, thereby estimating the distribution of the positional features between the user node and the signal source nodes. It is further designed that the above distribution is inferred based on a deep learning neural network, distribution information of each positional feature is learned from a high-dimensional signal, and the network is trained by acquiring received signals in different complex environments, to obtain a network parameter that can be estimated from the received signals, thereby achieving efficient and high-precision positioning of the user.

In summary, conventional positioning methods generally have two steps: first, single-value estimation (SVE) of a positional feature such as a distance or an angle is solved from the received signals from the signal source nodes, and then the single-value estimation of the positional feature obtained based on the received signal(s) of one or more signal source nodes is used for positioning by means of geometric relationships. The estimated value of the positional feature directly obtained from the received wireless signal has many deviation sources, and especially in a complex environment with multipath and non-line-of-sight situations, it is difficult to obtain an accurate estimated value. The deviation of the estimated positional feature value may seriously affect the positioning result.

In the embodiments of the present disclosure, distribution information of the positional features such as distances or angles may be estimated from the received signals, instead of estimating a single-valued point of a positional feature such as the distance or the angle. In a first aspect, the distribution estimation is used instead of the single-valued point estimation, thereby providing more position-related information, and improving the precision and robustness of positioning. In a second aspect, modeling of environmental features of signal acquisition is added; the influences of different environments on position estimation is introduced in the form of conditional probability; and environmental tags in received signal acquisition environments are introduced to train the network, to decouple the environmental features from the signal features, so that environmental interference is further explicitly excluded compared with conventional positioning solutions, thereby improving the robustness of positioning. In a third aspect, the designed algorithm has low complexity, and can meet high real-time requirements of actual application scenarios. Specifically, since the inference algorithms of the distribution of the environmental information and the distributions of the positional features are implemented by neural networks, after offline training is completed, soft information estimation and positioning with linear time complexity can be implemented only by storing network parameters. They are easy to deploy and process for hardware computation, and the extraction of the distribution information is data-driven and involves automatic learning, which makes full use of all information of high-dimensional received signals compared with conventional methods, has low algorithm complexity, and can achieve positioning with high precision and reduced computation. Therefore, the solution is easily applied to and expanded in an actual positioning system based on radio frequency signals, so that a high-precision real-time sensing service platform suitable for consumer-level and industrial scenarios is built.

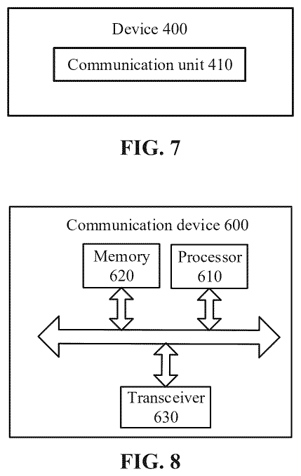

The method embodiments of the present disclosure have been described in detail above with reference to FIGS. 2 to 6, and apparatus embodiments of the present disclosure will be described in detail below with reference to FIGS. 7 to 10. It should be understood that the apparatus embodiments and the method embodiments correspond to each other, and reference may be made to the method embodiments for similar descriptions.

FIG. 7 illustrates a schematic block diagram of a method 400 for wireless communication according to an embodiment of the present disclosure. As illustrated in FIG. 7, the device 400 includes:
a processing unit 410, configured to obtain distributions of positional features between a user node and at least three signal source nodes; and
determine a position of the user node according to the distributions of the positional features between the user node and the at least three signal source nodes.

In some embodiments, the processing unit 410 is further configured to:
determine first distributions according to signals sent by the at least three signal source nodes and received by the user node, wherein the first distributions are distributions of environmental information included in the signals;
determine second distributions according to the signals sent by the at least three signal source nodes and received by the user node, wherein the second distributions are distributions of the positional features of the signals under the environmental information of the first distributions; and
determine a target distribution according to the first distributions and second distributions, wherein the target distribution is a distribution of the positional features included in the signals.

In some embodiments, the processing unit 410 is further configured to:
determine the target distribution p(x|r) according to the following formula:

$$p ( x \vert r ) = {\sum }_{z} p ( z \vert r ) p ( x \vert r , z )$$

where r represents the received signal, z represents environmental information, x represents the positional feature, p(z|r) represents the distribution of the environmental information z included in the signal r, and p(x|r, z) represents the distribution of the positional feature included in the signal r under the environmental information z.

In some embodiments, the processing unit 410 is further configured to:
determine, according to the first distributions, an environmental tag corresponding to an environment in which the user node is located.

In some embodiments, the target distribution is obtained based on a target model, wherein the target model includes a first network module and a second network module, the first network module is used to infer a first distribution, and the second network module is used to infer a second distribution.

In some embodiments, an input of the first network module is the received signal, and an output of the first network module is a distribution parameter corresponding to the first distribution.

In some embodiments, the first distribution is a variational distribution.

In some embodiments, inputs of the second network module are the received signal and environmental information outputted by the first network module, and an output of the second network module is a distribution parameter corresponding to the second distribution.

In some embodiments, the second distribution is a Gaussian distribution.

In some embodiments, the target model further includes:
a third network module, used to infer a distribution of the environmental tag corresponding to the environment where the user node is located; and
a fourth network module, used to derive a distribution of the received signal.

In some embodiments, an input of the third network module is the output of the first network module, and an input of the fourth network module is the output of the first network module.

In some embodiments, a global loss function L of the target model is:

$$L = {α}_{AE} {L}_{AE} + {α}_{dist} {L}_{dist} + {α}_{env} {L}_{env}$$

where α_{AE}, α_{dist}, αₑₙᵥ are training hyperparameters, L_{AE} is a loss function of the first network module and the fourth network module, L_{dist} is a loss function of the second network module, and Lₑₙᵥ is a loss function of the third network module.

33. The device according to claim 32, wherein the loss function L_{AE} of the first network module and the fourth network module is:

$${{L}_{AE} ( r ; θ , ϕ ) = ‖ r - \hat{r} ( r ; θ , ϕ ) ) ‖}^{2} + {D}_{KL} ( Cat ( z ; {π}_{z} ( r ; ϕ ) ) ‖ U ( z ; 1 , M ) )$$

where r represents the received signal, θ is a neural network parameter of the fourth network module, ϕ is a neural network parameter of the first network module, D_{KL} represents a KL divergence between distributions, Cat represents a categorical distribution, U represents a uniform distribution, z represents the environmental information, π_{z} represents the distribution parameter of environmental information, M is a parameter related to environmental complexity, and \hat{r}(r; θ, ϕ) represents a distribution of the received signal derived by the fourth network module.

In some embodiments, the loss function L_{dist} of the second network module is:

$${L}_{dist} ( r , z ; ϕ , {φ}_{x} ) = {E}_{q ( z \vert r )} {D}_{KL} ( {p}_{D} ( x ) ‖ N ( x ; {μ}_{x} ( r , z ; {φ}_{x} ) , {σ}_{x}^{2} ( r , z ; {φ}_{x} ) ) )$$

where r represents the received signal, z represents the environmental information, ϕ is the neural network parameter of the first network module, da is a neural network parameter of the second network module, q(z|r) represents a variational distribution, E_{q(z|r)} represents an expectation of q(z|r), p_{D}(x) is an empirical distribution of a position parameter x, D_{KL} represents the KL divergence between the distributions, N represents the Gaussian distribution, and μₓ and σₓ² represent distribution parameters of the Gaussian distribution.

In some embodiments, the loss function Lₑₙᵥ of the third network module is:

$${L}_{env} ( r , l ; ϕ , {φ}_{l} ) = {E}_{q ( z \vert r )} {D}_{KL} ( {p}_{D} ( l ) ‖ Cat ( l ; {π}_{l} ( z ; {φ}_{l} ) ) )$$

where r represents the received signal, 1 represents the environmental tag of the environment in which the user node is located, ϕ is the neural network parameter of the first network module, φ₁ is a neural network parameter of the third network module, q(z|r) represents the variational distribution, E_{q(z|r)} represents the expectation of q(z|r), p_{D}(l) is the empirical distribution of the environmental tag 1, D_{KL} represents the KL divergence between the distributions, πₗ represents the distribution parameter of the environmental tag 1, Cat represents the categorical distribution, and πₗ represents a distribution parameter of the categorical distribution.

In some embodiments, the processing unit 410 is further configured to:
construct a training dataset, wherein the training dataset includes received signal information under a plurality of combinations of signal source nodes and user nodes, and ground truth values of the positional features between the user nodes and the signal source nodes; and
by using the received signal information in the training dataset as an input, using the distribution of the positional feature and the distribution of the environmental tag as outputs, and using a deviation between an estimated value and a ground truth value of the positional feature in the training dataset as supervision, train the target model to obtain a neural network parameter of the target model.

In some embodiments, the processing unit 410 is further configured to:
input signals sent by the at least three signal source nodes and received by the user node into the trained target model, and output at least three first distributions and at least three second distributions, wherein the at least three first distributions and the at least three second distributions are in one to-one correspondence with the signals sent by the at least three signal source nodes;
estimate a distribution of the positional feature included in a corresponding signal according to each first distribution and a second distribution corresponding to the first distribution; and
according to the distributions of the positional features included in the signals sent by the at least three signal source nodes and the positions of the at least three signal source nodes, determining the position of the user node.

In some embodiments, the processing unit 410 is further configured to:
determine at least three regions according to the distribution of the positional feature included in the signal sent by each of the at least three signal source nodes and the positions of the at least three signal source nodes, wherein each of the at least three regions corresponds to one of the at least three signal source nodes, and each region is determined according to the distribution of the positional feature included in the signal sent by the corresponding signal source node; and
determine a point having a maximum probability value in the at least three regions as the position of the user node.

In some embodiments, each positional feature includes at least one of: a distance, an angle, or a received signal strength (RSS).

In some embodiments, a signal source node is a network device or another user node.

In some embodiments, the device 400 is the user node, or the device is a location management function (LMF) entity.

Optionally, in some embodiments, the communication unit may be a communications interface or a transceiver, or an input/output interface of a communications chip or a system-on-chip. The processing unit may be one or more processors.

It should be understood that the device 400 according to the embodiments of the present disclosure may correspond to the user node or positioning node in the method embodiments of the present disclosure, and the foregoing and other operations and/or functions of the units in the device 400 are respectively intended to implement corresponding processes of the user node or positioning node in the method 200 illustrated in FIGS. 2 to 6, which will not be repeated here for the sake of brevity.

FIG. 8 is a schematic structural diagram of a communication device 600 provided in an embodiment of the present disclosure. The communication device 600 illustrated in FIG. 8 includes a processor 610. The processor 610 may call and run a computer program from a memory so as to implement the method in the embodiments of the present disclosure.

Optionally, as illustrated in FIG. 8, the communication device 600 may further include a memory 620. The processor 610 may call and run a computer program from the memory 620 so as to implement the method in the embodiments of the present disclosure.

The memory 620 may be one separate component independent of the processor 610, or may be integrated in the processor 610.

Optionally, as illustrated in FIG. 8, the communication device 600 may further include a transceiver 630. The processor 610 may control the transceiver 630 to perform communication with other devices. Specifically, the transceiver may transmit information or data to other devices, or receive information or data transmitted by other devices.

The transceiver 630 may include a transmitter and a receiver. The transceiver 630 may further include an antenna, and the number of antennas may be one or more.

Optionally, the communication device 600 may specifically be the user node in the embodiments of the present disclosure, and the communication device 600 may implement corresponding processes implemented by the positioning node in each method of the embodiments of the present disclosure, which will not be repeated here for the sake of brevity.

Optionally, the communication device 600 may specifically be the positioning node in the embodiments of the present disclosure, and the communication device 600 may implement corresponding processes implemented by the positioning node in each method of the embodiments of the present disclosure, which will not be repeated here for the sake of brevity.

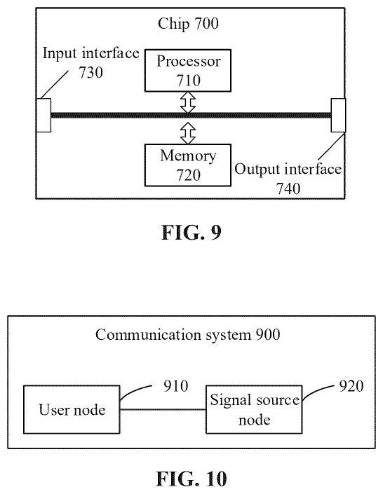

FIG. 9 is a schematic structural diagram of a chip according to an embodiment of the present disclosure. The chip 700 illustrated in FIG. 9 includes a processor 710. The processor 710 may call and run a computer program from a memory so as to implement the method in the embodiments of the present disclosure.

Optionally, as illustrated in FIG. 9, the chip 700 may further include a memory 720. The processor 710 may call and run a computer program from the memory 720 so as to implement the method in the embodiments of the present disclosure.

The memory 720 may be one separate component independent of the processor 710, or may be integrated in the processor 710.

Optionally, the chip 700 may further include an input interface 730. The processor 710 may control the input interface 730 to perform communication with other devices or chips. Specifically, the input interface may obtain information or data transmitted by other devices or chips.

Optionally, the chip 700 may further include an output interface 740. The processor 710 may control the output interface 740 to perform communication with other devices or chips. Specifically, the output interface may output information or data to other devices or chips.

Optionally, the chip may be applied to the positioning node in the embodiments of the present disclosure, and the chip may implement corresponding processes implemented by the positioning node in each method of the embodiments of the present disclosure, which will not be repeated here for the sake of brevity.

Optionally, the chip may be applied to the user node in the embodiments of the present disclosure, and the chip may implement corresponding processes implemented by the user node in each method of the embodiments of the present disclosure, which will not be repeated here for the sake of brevity.

It should be understood that the chip mentioned in the embodiment of the present disclosure may also be referred to as a system-level chip, a system chip, a chip system, or a system-on-chip chip, or the like.

FIG. 10 is a schematic block diagram of a communication system 900 provided in an embodiment of the present disclosure. As illustrated in FIG. 10, the communication system 900 includes a user node 910 and a signal source node 920.

The user node 910 may be used to implement corresponding functions implemented by the user node in the method described above, and the signal source node 920 may be used to implement corresponding functions implemented by the signal source nodes in the method described above, which will not be repeated here for the sake of brevity.

Optionally, when the method 200 is performed by the positioning node, the communication system may further include a positioning node used to perform corresponding processes in the method 200, which will not be repeated here for the sake of brevity.

It should be understood that the processor in the embodiments of the present disclosure may be an integrated circuit chip with a signal processing capability. During implementation, each step in the method embodiments described above may be completed by an integrated logic circuit of hardware in a processor or instructions in the form of software. The above processor may be a general-purpose processor, a Digital Signal Processor (DSP), an Application Specific Integrated Circuit (ASIC), a Field Programmable Gate Array (FPGA) or other programmable logic devices, a discrete gate or transistor logic device, or a discrete hardware component. The various methods, steps, and logical block diagrams disclosed in the embodiments of the present disclosure may be implemented or executed. The general-purpose processor may be a microprocessor, or the processor may also be any conventional processor, etc. The steps of the methods disclosed in combination with the embodiments of the present disclosure may be directly executed and completed by a hardware decoding processor, or executed and completed by a combination of hardware and software modules in the decoding processor. Software modules may be located in a mature storage medium in the present field such as a random access memory, a flash memory, a read-only memory, a programmable read-only memory, an electrically erasable programmable memory, or a register. The storage medium is located in the memory, and the processor reads the information in the memory, and completes the steps of the above methods in combination with its hardware.

It can be understood that the memory in the embodiments of the present disclosure may be a volatile memory or a nonvolatile memory, or may include both volatile and nonvolatile memories. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM) or a flash memory. The volatile memory may be a random access memory (RAM), which acts as an external cache. By way of example, but not by way of limitation, many forms of RAMs are available, such as static random access memories (Static RAM, SRAM), dynamic random access memories (Dynamic RAM, DRAM), synchronous dynamic random access memories (Synchronous DRAM, SDRAM), double data rate synchronous dynamic random access memories (Double Data Rate SDRAM, DDR SDRAM), enhanced synchronous dynamic random access memories (Enhanced SDRAM, ESDRAM), synchronous link dynamic random access memories (Synchlink DRAM, SLDRAM) and direct memory bus random access memories (Direct Rambus RAM, DR RAM). It should be noted that the memory in the systems and methods described herein is intended to include, but is not limited to, the foregoing and any other suitable type of memory.

It should be understood that the above-mentioned memory is illustrative but not restrictive. For example, the memory in the embodiments of the present disclosure may also be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synch link DRAM, SLDRAM), a direct memory bus random access memory (Direct Rambus RAM, DR RAM), or the like. That is, the memory in the embodiments of the present disclosure is intended to include, but is not limited to, the foregoing and any other suitable type of memory.

A computer-readable storage medium for storing a computer program is further provided in an embodiment of the present disclosure.

Optionally, the computer-readable storage medium may be applied to the user node or positioning node in the embodiments of the present disclosure, and the computer program causes a computer to perform corresponding processes implemented by the user node or positioning node in each method of the embodiments of the present disclosure, which will not be repeated here for the sake of brevity.

A computer program product including computer program instructions is further provided in an embodiment of the present disclosure.

Optionally, the computer program product may be applied to the user node or positioning node in the embodiments of the present disclosure, and the computer program instructions cause a computer to perform corresponding processes implemented by the user node or positioning node in each method of the embodiments of the present disclosure, which will not be repeated here for the sake of brevity.

A computer program is further provided in an embodiment of the present disclosure.

Optionally, the computer program may be applied to the user node or positioning node in the embodiments of the present disclosure, and the computer program, when run on a computer, causes the computer to perform corresponding processes implemented by the user node or positioning node in each method of the embodiments of the present disclosure, which will not be repeated here for the sake of brevity.

A person skilled in the art can appreciate that the units and algorithm steps of the examples described in combination with the embodiments disclosed herein can be implemented by electronic hardware, or a combination of computer software and electronic hardware. These functions are executed in hardware or software, depending on the specific applications and design constraints of the technical solutions. A professional skilled person may use different methods for each specific application to implement the described functions, but said implementation should not be considered to exceed the scope of the present disclosure.

It can be clearly understood by a person skilled in the art that for the convenience and brevity of the description, reference may be made to the corresponding processes in the foregoing method embodiments for the specific working process of the systems, apparatuses and units described above, which will not be repeated here.

In several embodiments provided by the present disclosure, it should be understood that the disclosed systems, apparatuses, and methods may be implemented in other manners. For example, the apparatus embodiments described above are merely illustrative. For example, the division of the units is only a logical function division. During actual implementation, there may be other division methods. For example, a plurality of units or components may be combined or integrated into another system, or some features may be ignored or not implemented. Furthermore, the displayed or discussed coupling or direct coupling or communication connections may be by means of some interfaces, and the indirect coupling or communication connections of apparatuses or units may be in electrical, mechanical or other forms.

The units described as separate components may or may not be physically separated, and the components displayed as units may or may not be physical units, that is, they may be located in one place, or may be distributed to a plurality of network units. A part or all of the units may be selected according to actual needs to achieve the objective of the solution of the present embodiment.

In addition, the functional units in various embodiments of the present disclosure may be integrated in one processing unit, or each unit may be individually physically present, or two or more units may be integrated into one unit.

If the functions described above are implemented in the form of software function units and sold or used as separate products, they may be stored in a computer-readable storage medium. Based on such understanding, an essential part of the technical solution of the present disclosure, or the part thereof that contributes to the prior art, or a part of the technical solution may be embodied in the form of a software product. The computer software product is stored in a storage medium, and includes several instructions used to enable a computer device (which may be a personal computer, a server, a network device, or the like) perform all or part of the steps of the methods described in the various embodiments of the present disclosure. The foregoing storage medium includes: a U disk, a mobile hard disk, a Read Only Memory (ROM), a Random Access Memory (RAM), a magnetic disk, an optical disk, or various media that can store program codes.

The detailed description of the present disclosure is merely described above, but the scope of protection of the present disclosure is not limited thereto. Any person skilled in the art can easily conceive of changes or substitutions within the technical scope disclosed in the present disclosure, and all of the changes or substitutions should be covered by the scope of protection of the present disclosure. Therefore, the scope of protection of the present disclosure should be defined by the scope of protection of the claims.

1. A method for wireless communication, comprising:
obtaining distributions of positional features between a user node and at least three signal source nodes; and
determining a position of the user node according to the distributions of the positional features between the user node and the at least three signal source nodes.

2. The method according to claim 1, wherein obtaining the distributions of positional features between the user node and the at least three signal source nodes comprises:
determining first distributions according to signals sent by the at least three signal source nodes and received by the user node, wherein the first distributions are distributions of environmental information included in the signals;
determining second distributions according to the signals sent by the at least three signal source nodes and received by the user node, wherein the second distributions are distributions of the positional features of the signals under the environmental information of the first distributions; and
determining a target distribution according to the first distributions and second distributions, wherein the target distribution is a distribution of the positional features included in the signals.

3. The method according to claim 2, wherein determining the target distribution according to the first distributions and second distributions comprises:
determining the target distribution p(x|r) according to the following formula:
$$p ( x \vert r ) = {\sum }_{z} p ( z \vert r ) p ( x \vert r , z )$$
where r represents a received signal, z represents the environmental information, x represents the positional feature, p(z|r) represents the distribution of the environmental information z included in the signal r, and p(x|r, z) represents the distribution of the positional feature included in the signal r under the environmental information z.

4. The method according to claim 2, further comprising:
determining, according to the first distributions, an environmental tag corresponding to an environment in which the user node is located.

5. The method according to claim 2, wherein the target distribution is obtained based on a target model, the target model comprises a first network module and a second network module, the first network module is used to infer a first distribution, and the second network module is used to infer a second distribution;
wherein an input of the first network module is a received signal, and an output of the first network module is a distribution parameter corresponding to the first distribution;
wherein the first distribution is a variational distribution.

6. The method according to claim 5, wherein inputs of the second network module are a received signal and environmental information outputted by the first network module, and an output of the second network module is a distribution parameter corresponding to the second distribution;
wherein the second distribution is a Gaussian distribution.

7. The method according to claim 5, wherein the target model further comprises:
a third network module, used to infer a distribution of an environmental tag corresponding to an environment where the user node is located; and
a fourth network module, used to derive a distribution of a received signal;
wherein an input of the third network module is an output of the first network module, and an input of the fourth network module is the output of the first network module.

8. The method according to claim 7, wherein a global loss function L of the target model is:
$$L = {α}_{AE} {L}_{AE} + {α}_{dist} {L}_{dist} + {α}_{env} {L}_{env}$$
where α_{AE}, α_{dist}, αₑₙᵥ are training hyperparameters, L_{AE} is a loss function of the first network module and the fourth network module, L_{dist} is a loss function of the second network module, and Lₑₙᵥ is a loss function of the third network module.

9. The method according to claim 8, wherein the loss function L_{AE} of the first network module and the fourth network module is:
$${{L}_{AE} ( r ; θ , ϕ ) = ‖ r - \hat{r} ( r ; θ , ϕ ) ) ‖}^{2} + {D}_{KL} ( Cat ( z ; {π}_{z} ( r ; ϕ ) ) ‖ U ( z ; 1 , M ) )$$
where r represents a received signal, θ is a neural network parameter of the fourth network module, ϕ is a neural network parameter of the first network module, D_{KL} represents a Kullback-Leibler (KL) divergence between distributions, Cat represents a categorical distribution, U represents a uniform distribution, z represents the environmental information, π_{z} represents a distribution parameter of the environmental information, M is a parameter related to environmental complexity, and \hat{r}(r; θ, ϕ) represents a distribution of the received signal derived by the fourth network module.

10. The method according to claim 8, wherein the loss function L_{dist} of the second network module is:
$${L}_{dist} ( r , z ; ϕ , {φ}_{x} ) = {E}_{q ( z \vert r )} {D}_{KL} ( {p}_{D} ( x ) ‖ N ( x ; {μ}_{x} ( r , z ; {φ}_{x} ) , {σ}_{x}^{2} ( r , z ; {φ}_{x} ) ) )$$
where r represents a received signal, z represents the environmental information, ϕ is a neural network parameter of the first network module, φ_{d} is a neural network parameter of the second network module, q(z|r) represents a variational distribution, E_{q(z|r)} represents an expectation of q(z|r), p_{D}(x) is an empirical distribution of a position parameter x, D_{KL} represents a KL divergence between distributions, N represents a Gaussian distribution, and μₓ and σₓ² represent distribution parameters of the Gaussian distribution;
wherein the loss function Lₑₙᵥ of the third network module is:
$${L}_{env} ( r , l ; ϕ , {φ}_{l} ) = {E}_{q ( z \vert r )} {D}_{KL} ( {p}_{D} ( l ) ‖ Cat ( l ; {π}_{l} ( z ; {φ}_{l} ) ) )$$
where r represents a received signal, l represents the environmental tag of the environment in which the user node is located, ϕ is a neural network parameter of the first network module, or is a neural network parameter of the third network module, q(z|r) represents a variational distribution, E_{q(z|r)} represents an expectation of q(z|r), p_{D}(l) is an empirical distribution of the environmental tag l, D_{KL} represents a KL divergence between distributions, πₗ represents a distribution parameter of the environmental tag l, Cat represents a categorical distribution, and πₗ represents a distribution parameter of the categorical distribution.

11. A device for wireless communication, comprising: a processor and a memory, wherein the memory is used to store a computer program, and the processor is used to call and run the computer program stored in the memory to cause the device to:
obtain distributions of positional features between a user node and at least three signal source nodes; and
determine a position of the user node according to the distributions of the positional features between the user node and the at least three signal source nodes.

12. The device according to claim 11, wherein the processor is further configured to cause the device to:
determine first distributions according to signals sent by the at least three signal source nodes and received by the user node, wherein the first distributions are distributions of environmental information included in the signals;
determine second distributions according to the signals sent by the at least three signal source nodes and received by the user node, wherein the second distributions are distributions of the positional features of the signals under the environmental information of the first distributions; and
determine a target distribution according to the first distributions and second distributions, wherein the target distribution is a distribution of the positional features included in the signals.

13. The device according to claim 12, wherein the target distribution is obtained based on a target model, the target model comprises a first network module and a second network module, the first network module is used to infer a first distribution, and the second network module is used to infer a second distribution.

14. The device according to claim 13, wherein the target model further comprises:
a third network module, used to infer a distribution of an environmental tag corresponding to an environment where the user node is located; and
a fourth network module, used to derive a distribution of a received signal;
wherein an input of the third network module is an output of the first network module, and an input of the fourth network module is the output of the first network module.

15. The device according to claim 13, wherein the processor is further configured to cause the device to:
construct a training dataset, wherein the training dataset comprises received signal information under a plurality of combinations of signal source nodes and user nodes, and ground truth values of the positional features between the user nodes and the signal source nodes; and
by using the received signal information in the training dataset as an input, using the distribution of the positional feature and a distribution of an environmental tag as outputs, and using a deviation between an estimated value and a ground truth value of the positional feature in the training dataset as supervision, train the target model to obtain a neural network parameter of the target model.

16. The device according to claim 15, wherein the processor is further configured to cause the device to:
input the signals sent by the at least three signal source nodes and received by the user node into the trained target model, and output at least three first distributions and at least three second distributions, wherein the at least three first distributions and the at least three second distributions are in one to-one correspondence with the signals sent by the at least three signal source nodes;
estimate a distribution of the positional feature included in a corresponding signal according to each first distribution and a second distribution corresponding to the first distribution; and
determine the position of the user node according to the distributions of the positional features included in the signals sent by the at least three signal source nodes and the positions of the at least three signal source nodes.

17. The device according to claim 11, wherein the processor is further configured to cause the device to:
according to a distribution of the positional feature included in a signal sent by each of the at least three signal source nodes and the positions of the at least three signal source nodes, determine at least three regions, wherein each of the at least three regions corresponds to one of the at least three signal source nodes, and each region is determined according to the distribution of the positional feature included in the signal sent by the corresponding signal source node; and
determine a point having a maximum probability value in the at least three regions as the position of the user node.

18. The device according to claim 11, wherein each positional feature comprises at least one of: a distance, an angle, or a received signal strength (RSS).

19. The device according to claim 11, wherein the signal source nodes are network devices or other user nodes;
wherein the device is the user node, or the device is a location management function (LMF) entity.

20. A non-transitory computer-readable storage medium, used to store a computer program, wherein the computer program causes a computer to:
obtain distributions of positional features between a user node and at least three signal source nodes; and
determine a position of the user node according to the distributions of the positional features between the user node and the at least three signal source nodes.
